(19) United States
(12) Patent Application Publication
(10) Pub. No.: US 2012/0062826 A1
(43) Pub. Date: Mar. 15, 2012

(54) LIQUID CRYSTAL DEVICE, MANUFACTURING METHOD OF LIQUID CRYSTAL DEVICE, AND ELECTRONIC APPARATUS

(75) Inventor: Takaaki Tanaka, Toshima-ku (JP)

(73) Assignee: Seiko Epson Corporation, Tokyo (JP)

(21) Appl. No.: 13/224,869

(22) Filed: Sep. 2, 2011

(30) Foreign Application Priority Data
Sep. 10, 2010 (JP) 2010-202772

(51) Int. Cl. G02F 1/1337

(52) U.S. Cl. 349/123; 349/191

(57) ABSTRACT

A liquid crystal device includes a vertical alignment layer that is disposed on the side facing a liquid crystal layer in at least one of the pair of substrates and substantially vertically aligns liquid crystal molecules of the liquid crystal layer; and an alignment restriction layer that is disposed on the side facing the liquid crystal layer of the vertical alignment layer and restricts the alignment direction of the liquid crystal molecules, in which the alignment restriction layer is formed by polymerization of an atom transfer radical polymeric initiator bonded to the vertical alignment layer and a radical polymeric monomer contained in the liquid crystal layer.

### BACKGROUND

1. Technical Field

The present invention relates to a liquid crystal device, a manufacturing method of a liquid crystal device, and an electronic apparatus.

2. Related Art

There is, for example, a TFT (Thin Film Transistor) active matrix driving type liquid device that is used as a light valve of a liquid crystal projector, as the liquid crystal device. An alignment layer for aligning liquid crystal molecules in a predetermined direction is disposed at a side facing the liquid crystal layers of a pair of substrates, in a liquid crystal device.

As a method of forming an alignment layer, there is, for example, a method of forming an alignment layer made of an inorganic material, using oblique deposition on a substrate. Next, a technology that forms a thin layer that restricts alignment on an alignment layer, for example, as described in JP-A-2002-357830 and JP-A-2009-276445, in order to implement a stable alignment state of liquid crystal molecules on an alignment layer is disclosed. The thin layer is formed by radiating light to a liquid crystal layer containing a photopolymerizable composition and performing photo polymerization on the liquid crystal layer.

However, since the technology described in JP-A-2002-357830 and JP-A-2009-276445 polymerizes a photopolymerizable composition by radiating light to a liquid crystal layer interposed between a pair of substrates, the radiated light itself or a remaining reaction product damages the liquid crystal molecules, such that reliability (for example, insulation resistance) may be deteriorated. Further, since polymerization is not selectively performed at the alignment layer interface, there was a problem in that a polymer drifting in the liquid crystal layer may become an alignment defect of the liquid crystal layer.

### SUMMARY

An advantage of some aspects of the invention is implemented as the following embodiments or application examples.

### Application 1

According to an aspect of the invention, there is provided a liquid crystal device that is formed by interposing a liquid crystal layer between a pair of substrates. The liquid crystal device includes a vertical alignment layer and an alignment restriction layer. The vertical alignment layer is disposed on the side facing a liquid crystal layer in at least one of the pair of substrates and substantially vertically aligns liquid crystal molecules of the liquid crystal layer. The alignment restriction layer is disposed at the side facing the liquid crystal layer of the vertical alignment layer and restricts the alignment direction of the liquid crystal molecules. The alignment restriction layer is formed by polymerization of an atom transfer radical polymeric initiator bonded to the vertical alignment layer and a radical polymeric monomer contained in the liquid crystal layer.

According to the configuration, for example, by heating the liquid crystal layer, the alignment restriction layer is achieved by polymerizing the atom transfer radical polymeric initiator bonded to the vertical alignment layer with the radical polymeric monomer. Therefore, it is possible to dispose the alignment restriction layer for stable alignment only at the interface of the vertical alignment layer, such that it is possible to prevent the monomer from remaining on the liquid crystal layer. Therefore, it is possible to prevent a reaction product (impurities) from damaging the liquid crystal molecules or an alignment defect from being generated by drifting of the reaction product in the liquid crystal layer. Further, since the alignment restriction layers are formed by radiating light, it is possible to prevent the liquid crystal layer from being deteriorated. As a result, since damage to the liquid crystal layer is prevented, the visual quality can be improved.

### Application 2

In the liquid crystal device of the application, it is preferable that the vertical alignment layer may be an inorganic alignment layer containing silicon oxide as a main element, the atom transfer radical polymeric initiator may be a silane coupling agent, and a silanol group of the vertical alignment layer and the silane coupling agent may be bonded.

According to the configuration, since the silanol group and the silane coupling agent are bonded, it is possible to efficiently bond the atom transfer radical polymeric initiator to the inorganic alignment layer.

### Application 3

In the liquid crystal device of the application, it is preferable that the radical polymeric monomer may contain any one of an acrylate group, a methacrylate group, a vinyl group, a vinyloxy group, and an epoxy group, in the liquid crystal device.

According to the configuration, since the radical polymeric monomer contains the polymeric group, it is possible to polymerize the radical polymeric monomer with the atom transfer radical polymeric initiator by heating, such that it is possible to dispose the alignment restriction layer (atom transfer radical polymer layer) on the surface of the vertical alignment layer.

### Application 4

In the liquid crystal device of the application, it is preferable that the radical polymeric monomer may have a liquid-crystalline framework.

According to the configuration, since the liquid-crystalline framework is provided, even if a reaction product of the radical polymeric monomer remains in the liquid crystal layer, it is possible to prevent an adverse effect on the alignment of the liquid crystal molecules.

### Application 5

According to another aspect of the invention, there is provided a manufacturing method of a liquid crystal device that is formed by interposing a liquid crystal layer between a pair of substrates. The method includes: forming an alignment layer, which forms a vertical alignment layer substantially vertically aligning liquid crystal molecules in the liquid crystal layer, at a side facing the liquid crystal layer in at least one of the pair of substrates; applying an atom transfer radical polymeric initiator onto the surface of the vertical alignment layer; forming a liquid crystal panel by enclosing the liquid crystal layer containing a radical polymeric monomer between the pair of substrates; and forming an alignment restriction layer at the side facing the liquid crystal layer of the vertical alignment layer by reacting the atom transfer radical polymeric initiator with the radical polymeric monomer contained in the liquid crystal layer by heating the liquid crystal panel.

According to the method, since the alignment restriction layer for stable alignment is formed only at the interface of the alignment layer by applying an atom transfer radical polymeric initiator to the vertical alignment layer and by reacting the atom transfer radical polymeric initiator with a radical polymeric monomer, it is possible to prevent a monomer from remaining in the liquid crystal layer. Therefore, it is possible to prevent a reaction product (impurities) from damaging the liquid crystal molecules or an alignment defect from being generated by drifting of the reaction product in the liquid crystal layer. Further, since the alignment restriction layers are formed by radiating light, it is possible to prevent the liquid crystal layer from being deteriorated. As a result, since damage to the liquid crystal layer is prevented, the visual quality can be improved.

### Application 6

In the manufacturing method of a liquid crystal device, the vertical alignment layer may be an inorganic alignment layer containing silicon oxide as a main element, and the atom transfer radical polymeric initiator may be a silane coupling agent.

According to the method, since the silane group and the silane coupling agent of the inorganic alignment layer are bonded, it is possible to efficiently apply the atom transfer radical polymeric initiator onto the inorganic alignment layer.

### Application 7

In the manufacturing method of a liquid crystal device, it is preferable that the radical polymeric monomer may contain any one of an acrylate group, a methacrylate group, a vinly group, a vinyloxy group, and an epoxy group.

According to the method, since the radical polymeric monomer contains the polymeric group, it is possible to polymerize the radical polymeric monomer with the atom transfer radical polymeric initiator by heating, such that it is possible to form the alignment restriction layer (atom transfer radical polymer layer) on the surface of the vertical alignment layer.

### Application 8

In the manufacturing method of a liquid crystal device, it is preferable that the radical polymeric monomer may have a liquid-crystalline framework in the manufacturing method of a liquid crystal device.

According to the method, since the liquid-crystalline framework is provided, even if a reaction product of the radical polymeric monomer remains in the liquid crystal layer, it is possible to prevent an adverse effect on the alignment of the liquid crystal molecules.

### Application 9

According to still another aspect of the invention, there is provided an electronic apparatus equipped with the liquid crystal device.

According to the configuration, since the liquid crystal device described above is provided, it is possible to prevent an alignment defect, such that it is possible to provide an electronic apparatus that can implement high visual quality.

### BRIEF DESCRIPTION OF THE DRAWINGS

The invention will be described with reference to the accompanying drawings, wherein like numbers reference like elements.

FIG. 1 is a schematic plan view showing the structure of a liquid crystal device.

FIG. 2 is a schematic cross-sectional view taken along the line II-II of the liquid crystal device shown in FIG. 1.

FIG. 3 is an equivalent circuit diagram showing the electric configuration of a liquid crystal device.

FIG. 4 is a schematic cross-sectional view showing the structure of a liquid crystal device.

FIG. 5 is a flowchart showing a manufacturing method of a liquid crystal device in the order of the processes.

FIG. 6 is a schematic cross-sectional view showing a portion of processes in a manufacturing method of a liquid crystal device.

FIG. 7 is a table showing the relationship of an radiation time and a specific resistance value.

FIG. 8 is a schematic view showing the configuration of a liquid crystal projector, as an example of an electronic apparatus.

### DESCRIPTION OF EXEMPLARY EMBODIMENTS

Hereinafter, embodiments that implement the invention in detail are described with reference to the drawings. Further, the drawings used are appropriately enlarged or reduced such that the illustrated portions can be recognized. The embodiment is described by exemplifying a TFT (Thin Film Transistor) active matrix driving type liquid crystal device that is used as the light valve of a liquid crystal projector that is a projection type image apparatus, as an example.

### Configuration of Liquid Crystal Device

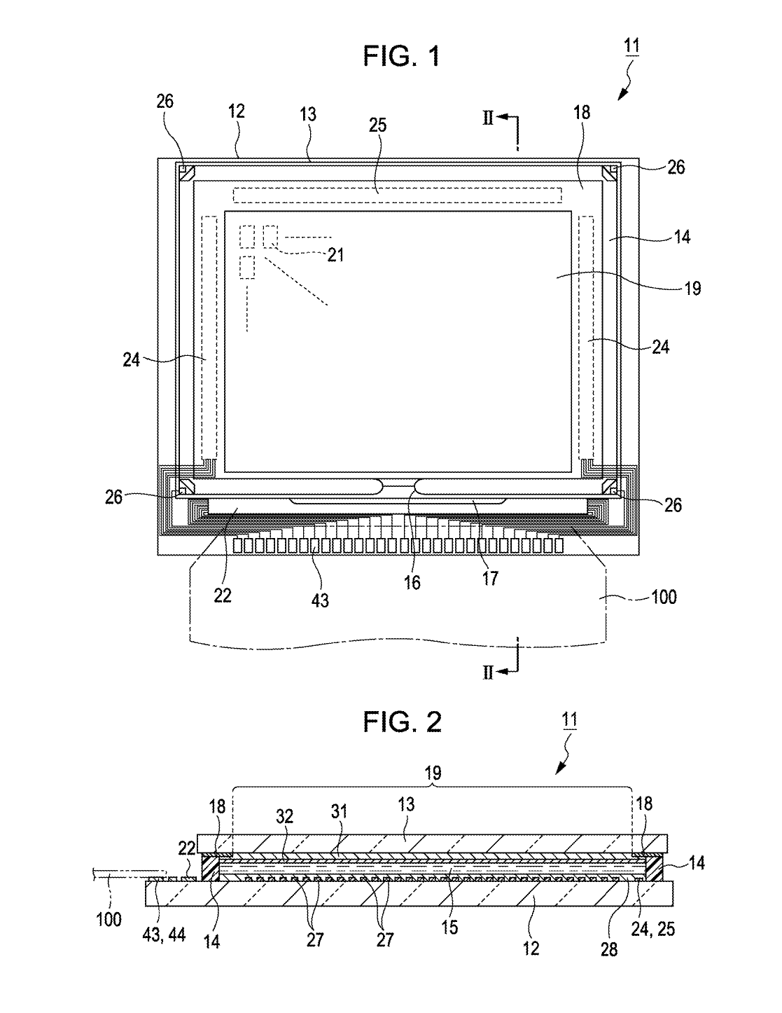

FIG. 1 is a schematic plan view showing the structure of a liquid crystal device. FIG. 2 is a schematic cross-sectional view taken along the line II-II of the liquid crystal device shown in FIG. 1. Hereinafter, the structure of a liquid crystal device is described with reference to FIG. 1 and FIG. 2.

As shown in FIG. 1 and FIG. 2, a liquid crystal device 11, for example, is a TFT active matrix type liquid crystal device using a thin film transistor (hereafter, referred to as a TFT (Thin Film Transistor) element) as a switching element of a pixel. In the liquid crystal device 11, a first substrate 12 and a second substrate 13 are bonded, with a sealant 14 having a substantially rectangular frame shape, in planar view, therebetween.

The first substrate 12 and the second substrate 13 are made of, for example, a translucent material, such as quartz. The liquid crystal device 11 has a configuration in which a liquid crystal layer 15 is enclosed within a region surrounded by the sealant 14. Further, a liquid crystal injection hole 16 for injecting liquid crystal is disposed at the sealant 14, and the liquid crystal injection hole 16 is sealed by a seal material 17.

As the liquid crystal layer 15, for example, a liquid crystal composition having negative dielectric anisotropy is used. In the liquid crystal device 11, a light shielding frame layer 18 having a rectangular frame shape in planar view and made of a light shielding material is formed on the second substrate 13, around the inner circumference of the sealant 14 and the region inside the light shielding frame layer 18 is a display region 19.

The light shielding frame layer 18, for example, is made of aluminum (Al), which is a light shielding material, and is disposed to divide the outer circumference of the display region 19 at the second substrate 13.

Pixels regions 21 are disposed in a matrix shape in the display region 19. The pixel regions 21 constitute one pixel that is the minimum display unit of the display region 19. A data line driving circuit 22 and a panel connection terminal 43 are formed along a side (the lower side in FIG. 1) of the first substrate 12, at the region outside the sealant 14. A flexible substrate 100 for connection with the outside is electrically connected to the panel connection terminal 43 through an FPC connection terminal 44.

Further, scanning line driving circuits 24 are formed along the two sides adjacent to one side, in the region inside the sealant 14. An inspection circuit 25 is formed at the other side (the upper side in FIG. 1) of the first substrate 12. The light shield frame layer 18 formed at the second substrate 13 is formed, for example, at a position opposite to the scanning line driving circuit 24 and the inspection circuit 25 (an overlapping position in a plane) which are formed on the first substrate 12.

Meanwhile, up/down conductive terminals 26, as up/down conductive portions, for electric conduction between the first substrate 12 and the second substrate 13 are disposed at the corners of the second substrate 13 (for example, four corners of the sealant 14).

Further, as shown in FIG. 2, a plurality of pixel electrodes 27 is formed at the liquid crystal layer 15 of the first substrate 12 and a first alignment layer 28 is formed to cover the pixel electrodes 27. The pixel electrodes 27 are conductive layers made of a transparent conductive material, such as ITO (Indium Tin Oxide).

Meanwhile, a grid-shaped light shielding layer (BM: Black Matrix) (not shown) is formed at the liquid crystal layer 15 of the second substrate 13 and a plane solid common electrode 31 is formed thereon. Further, a second alignment layer 32 is formed on the common electrode 31. The common electrode 31 is a conductive layer made of a transparent conductive material, such as ITO.

The liquid crystal device 11 is a transmissive type and a polarizer (not shown) or the like is disposed and used at the incident side and the exit side of light of the first substrate 12 and the second substrate 13. Further, the configuration of the liquid crystal device 11 is not limited thereto and may have a reflective type or a semitransparent type configuration.

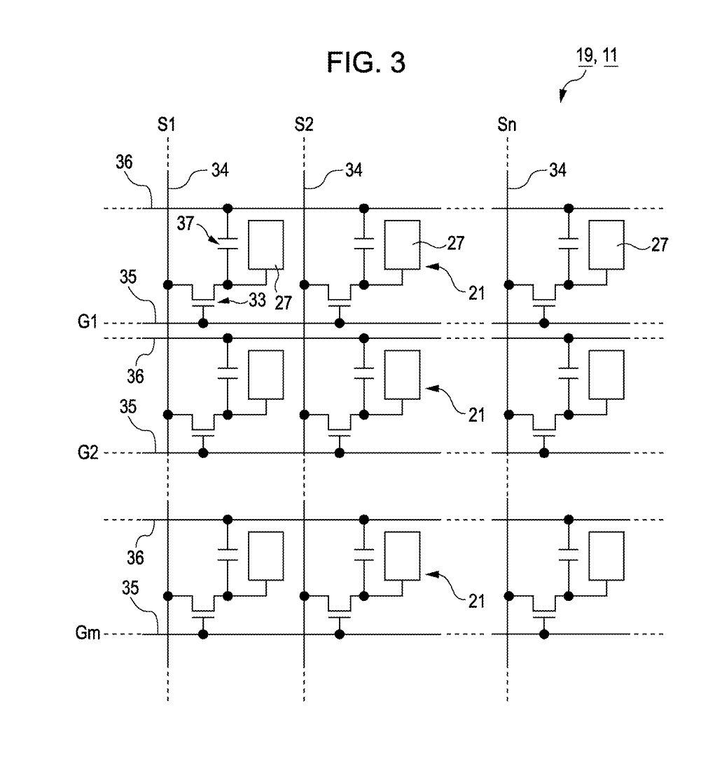

FIG. 3 is an equivalent circuit diagram showing the electric configuration of a liquid crystal device. Hereinafter, the electric configuration of the liquid crystal device is described with reference to FIG. 3.

As shown in FIG. 3, the liquid crystal device 11 has the plurality of pixel regions 21 constituting the display region 19. The pixel electrode 27 is disposed in each of the pixel region 21. Further, the TFT element 33 is formed in the pixel region 21.

The TFT element 33 is a switching element that performs conduction control to the pixel electrodes 27. Data lines 34 are electrically connected to the source of the TFT element 33. Image signals S1, S2, . . . , and Sn are supplied to the data lines 34, for example, from the data line driving circuit 22 (see FIG. 1).

Scanning lines 35 are electrically connected to the gate of the TFT element 33. Scanning signals G1, G2, . . . , and Gm are supplied in a pulse type to the scanning lines 35 at predetermined timings, for example, from the scanning line driving circuit 24 (see FIG. 1). Further, the pixel electrodes 27 are electrically connected to the drain of the TFT element 33.

By the scanning signals G1, G2, . . . , and Gm supplied from the gate lines 35, the TFT element 33 that is a switching element is turned on for a predetermined period, such that the image signals S1, S2, . . . , and Sn supplied from the data lines 34 are written on the pixel region 21 through the pixel electrodes 27 at predetermined timings.

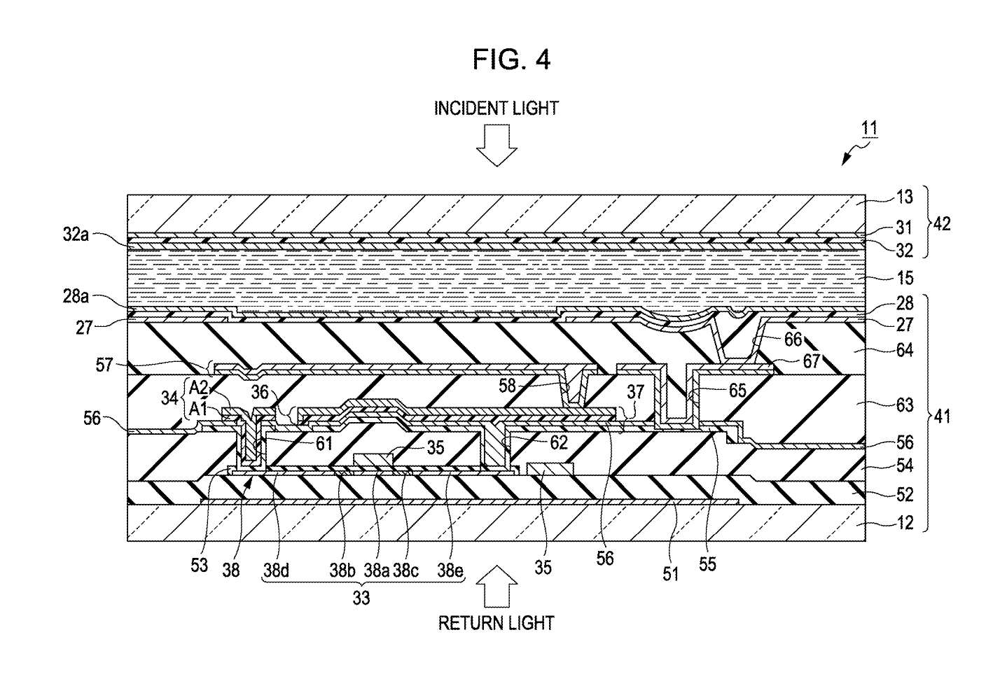

The image signals S1, S2, . . . , and Sn at a predetermined level, written on the pixel region 21, are held in a liquid crystal capacitor formed between the pixel electrodes 27 and the common electrode 31 (see FIG. 2) for a predetermined period. Further, in order to prevent the held image signals S1, S2, . . . , and Sn from leaking, a storage capacitor 37 is formed between a pixel potential-sided capacitance electrically connected to the pixel electrode 27 and a capacitance 36 electrically connected to a shield layer 57 (see FIG. 4) that is an example of a capacity wire.

As described above, when a voltage signal is applied to the liquid crystal layer 15, the alignment state of the liquid crystal molecules is changed by the applied voltage signal. Accordingly, incident light on the liquid crystal layer 15 is modulated and image light is produced.

FIG. 4 is a schematic cross-sectional view showing the structure of a liquid crystal device. Hereinafter, the structure of the liquid crystal device is described with reference to FIG. 4. Further, FIG. 4 shows the cross-sectional positional relationship of the components, using a visible measure.

As shown in FIG. 4, the liquid crystal device 11 includes an element substrate 41 that is one of a pair of substrates and an opposite substrate 42 that is the other of the pair of substrates, disposed at the opposite side. The first substrate 12 of the element substrate 41 and the second substrate 13 of the opposite substrate 42 are, for example, implemented by quartz substrates, as described above.

A lower light shielding layer 51 made of titanium (Ti) or chromium (Cr) is formed on the first substrate 12. The lower light shielding layer 51 is patterned in a grid shape in a plane and defines the opening regions of the pixels. A basic insulating layer 52 formed of a silicon oxide film or the like is formed on the first substrate 12 and the lower light shielding layer 51.

The TFT element 33 and the scanning line 35 are formed on the basic insulating layer 52. The TFT element 33 has an LDD (Lightly Doped Drain) structure, for example, and includes a semiconductor layer 38 made of polysilicon, a gate insulating layer 53 formed on the semiconductor layer 38, and a scanning line 35 made of a polysilicon layer or the like formed on the gate insulating layer 53. As described above, the scanning line 35 also functions as a gate electrode.

The semiconductor layer 38 includes a channel region 38a, a low-concentration source region 38b, a low-concentration drain region 38c, a high-concentration source region 38d, and a high-concentration drain region 38e. A channel is formed in the channel region 38a by an electric field from the scanning line 35. The first interlayer insulating layer 54 formed of a silicon oxide film or the like is formed on the basic insulating layer 52.

The storage capacitor 37 and the data line 34 are disposed on the first interlayer insulating layer 54. In the storage capacitor 37, a relay layer 55 that is a pixel potential-sided capacitance connected to the high-concentration drain region 38e and the pixel electrode 27 of the TFT element 33 and a capacitance 36 that is a fixed potential-sided capacitance are disposed opposite to each other through the dielectric layer 56.

The capacitance 36 and the data line 34 are formed as layers having a double-layered structure composed of a lower dielectric polysilicon layer A1 and an upper aluminum layer A2.

The capacitance 36 and the data line 34 contain aluminum having relatively excellent light reflection performance and polysilicon having relatively excellent light absorption performance, such that they can function as light shielding layers. Therefore, it is possible to stop traveling of incident light in respect to the semiconductor layer 38 of the TFT element 33 at the upper portion.

The capacitance 36 functions as a fixed potential-sided capacitance of the storage capacitor 37. In order to give fixed potential to the capacitance 36, as described above, it is electrically connected to the shield layer 57 given as fixed potential by being connected to a constant potential source outside the pixel region 21, through a contact hole 58.

A contact hole 61 that electrically connects the high-concentration source region 38d with the data line 34 of the TFT element 33 is formed through the first interlayer insulating layer 54. In other words, the data line 34 is electrically connected with the semiconductor layer 38 of the TFT element 33 through the contact hole 61 formed through the dielectric layer 56 and the first interlayer insulating layer 54. In detail, since the data line 34 has the double-layered structure, as described above, and the relay layer 55 is formed of a conductive polysilicon layer, the electric connection between the data line 34 and the semiconductor layer 38 is implemented by the conductive polysilicon layer. That is, the semiconductor layer 38, the polysilicon layer of the relay layer 55, the lower conductive polysilicon layer A1 of the data line 34, and the upper aluminum layer A2, are disposed from the lower portion.

Further, a contact hole 62 that electrically connects the high-concentration drain region 38e of the TFT element 33 with the relay layer 55 of the storage capacitor 37 is formed through the first interlayer insulating layer 54. A second interlayer insulating layer 63 formed of a silicon oxide film is formed on the first interlayer insulating layer 54.

A shield layer 57, for example, which is made of aluminum is formed on the second interlayer insulating layer 63. Further, the contact hole 58 that electrically connects the shield layer 57 with the capacitance 36, as described above, is formed through the second interlayer insulating layer 63. A third interlayer insulating layer 64 formed of a silicon oxide film is formed on the second interlayer insulating layer 63.

Contact holes 65 and 66 that electrically connect the pixel electrode 27 and the relay layer 55 are formed through the second interlayer insulating layer 63 and the third interlayer insulating layer 64. In detail, the contact hole 65 and the contact hole 66 are electrically connected through a second relay layer 67 formed on the second interlayer insulating layer 63. The second relay layer 67 has a double-layered structure composed of a lower aluminum layer and an upper nitride titanium film, the same layer configuration as the shield layer 57.

That is, the high-concentration drain region 38e and the pixel electrode 27 are electrically connected through the contact hole 62, the relay layer 55, the contact hole 65, the second relay layer 67, and the contact hole 66. The pixel electrodes 27 and the first alignment layer 28, which are described above, are formed on the third interlayer insulating layer 64.

The pixel electrodes 27 are formed in a matrix shape in a plane, and for example, formed of a transparent conductive layer, such as ITO. For a reflective type liquid crystal device, a material, such as aluminum, is used. Further, the first alignment layer 28 where an alignment process is applied in a predetermined direction is formed on the pixel electrodes 27. The first alignment layer 28 is an inorganic alignment layer made of an inorganic material, such as silicon oxide (SiO₂). Further, the first alignment layer 28 is also a vertical alignment layer that vertically aligns the liquid crystal molecules. A first alignment restriction layer 28a that restricts the alignment direction of the liquid crystal molecules is disposed on the surface of the first alignment layer 28 to prevent an alignment defect of the inorganic alignment layer.

The liquid crystal layer 15 where an electrooptic material, such as liquid crystal, is enclosed in a space surrounded by the sealant 14 (see FIG. 2) is disposed on the first alignment layer 28 (28a). A second alignment layer 32 where an alignment process is applied in a predetermined direction to cover the transparent common electrode 31 is formed at the side facing the liquid crystal layer 15 of the second substrate 13.

The second alignment layer 32 is an inorganic alignment layer made of an inorganic material, such as silicon oxide (SiO₂). Further, the second alignment layer 32 is also a vertical alignment layer that vertically aligns the liquid crystal molecules. A second alignment restriction layer 32a that restricts the alignment direction of the liquid crystal molecules is, similar to the first alignment layer 28, disposed on the surface of the second alignment layer 32 to prevent an alignment defect of the inorganic alignment layer. The first alignment restriction layer 28a and the second alignment restriction layer 32a are described later.

The liquid crystal layer 15 takes a predetermined alignment state by the first alignment layer 28 and the second alignment layer 32 in a state where an electric field is not applied from the pixel electrode 27. The sealant 14 is an adhesive made of photocrosslinkable resin or thermosetting resin, for example, for bonding the element substrate 41 and the opposite substrate 42 around it, and is mixed with a spacer, such as glass fiber or glass bead for defining the distance between both substrates at a predetermined value.

Further, when the material used to from the first alignment restriction layer 28a and the second alignment restriction layer 32a remains as a reaction product in the liquid crystal layer 15, a problem of bad alignment is generated. Hereinafter, a manufacturing method of the liquid crystal device 11, including the manufacturing method of the first alignment restriction layer 28a and the second alignment restriction layer 32a, is described.

### Manufacturing Method of Liquid Crystal Device

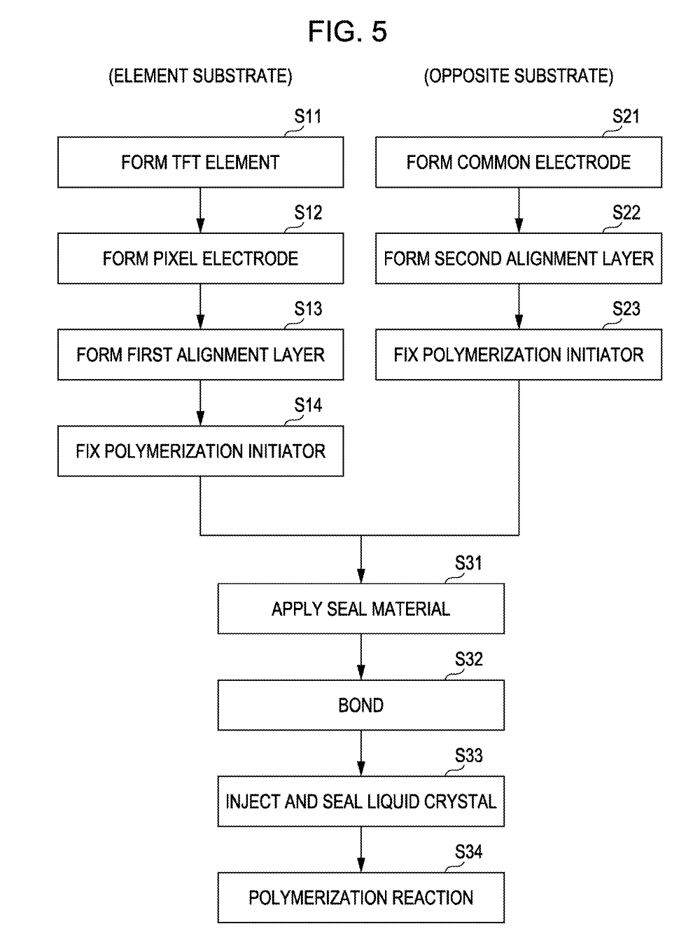

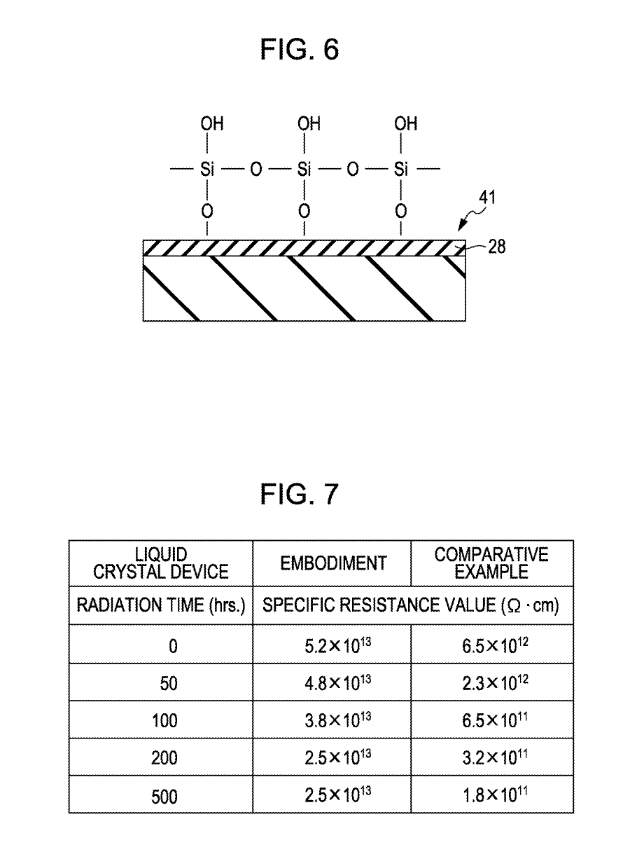

FIG. 5 is a flowchart showing a manufacturing method of a liquid crystal device in the order of the processes. FIG. 6 is a schematic cross-sectional view showing a portion of processes in a manufacturing method of a liquid crystal device. Hereinafter, a manufacturing method of the liquid crystal device is described with reference to FIG. 5 and FIG. 6.

A manufacturing method of the element substrate 41 is described first. In step S11, the TFT element 33 or the wires are formed on the first substrate 12 formed of a quartz substrate or the like. In detail, the TFT element 33 and the like are formed on the first substrate 12, using a well-known layer-forming technology, the photolithograph technology, and etching technology.

In Step S12, the pixel electrodes 27 are formed. In detail, as the same way of forming the TFT element 33 and the like, the pixel electrodes 27 are formed above the TFT element 33 on the first substrate 12, using the well-known layer-forming technology, the photolithograph technology, and etching technology.

In step S13 (alignment layer forming process), an inorganic alignment layer that is the first alignment layer 28 is formed above the pixel electrodes 27. The manufacturing method of an inorganic alignment layer is formed by oblique-depositing (oblique deposition) an inorganic material, such as silicon oxide (SiO₂), on the pixel electrodes 27 and the third interlayer insulating layer 64. A plurality of silanol groups (—OH) exists on the surface of the first alignment layer 28 (inorganic alignment layer), as shown in FIG. 6.

In step S14 (application process), a polymeric initiator is stuck (fixed) onto the surface of the first alignment layer 28 (inorganic alignment layer). In detail, an atom transfer radical polymeric initiator made in a silane coupling agent type is reaction-stuck onto the surface of the first alignment layer 28. As the reaction-sticking method, for example, a silane coupling agent is melted in an organic solvent and the element substrate 41 where the first alignment layer 28 is formed is immersed in (applied with) the inorganic solvent liquid. Accordingly, an atom transfer radical polymeric initiator is stuck on the surface of the first alignment layer 28 by bonding of the silanol group of the inorganic alignment layer and the silane coupling agent. Further, heat may be applied to promote the reaction.

For example, 2-(4-chlorosulfonylphenyl) ethyltrimethoxysilane shown in the following Chemical Formula 1 may be used as the polymeric initiator. Further, N-(4-chloromethylbenzoyl)-N-methylaminopropyl silane shown in the following Chemical Formula 2 may be used.

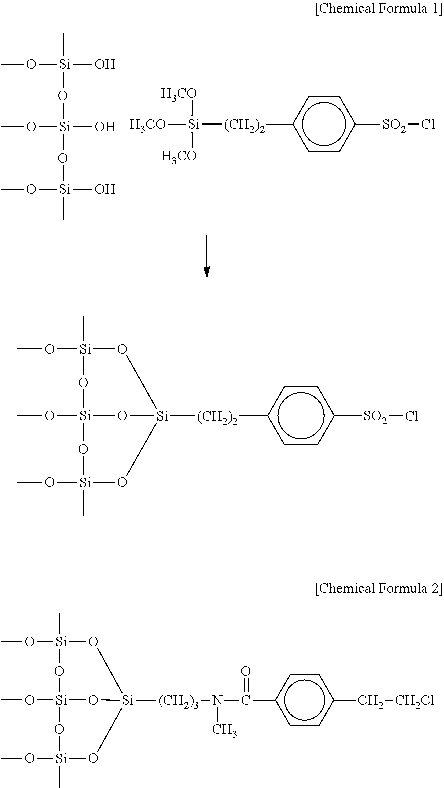

Thereafter, the element substrate 41 with the polymeric initiator stuck on the surface of the first alignment layer 28 is completed by washing unreacted substances sticking to the element substrate 41 and drying the element substrate 41. Next, a manufacturing method of the opposite substrate 42 is described.

First, in step S21, the common electrode 31 is formed on the second substrate 13 made of a translucent material of a quartz substrate by the well-known layer-forming technology, the photolithograph technology, and etching technology.

In step S22 (alignment layer forming process), an inorganic alignment layer that is the second alignment layer 32 is formed on the common electrode 31. The manufacturing method of the inorganic alignment layer is the same as the manufacturing method of the first alignment layer 28. First, an inorganic alignment layer is formed on the common electrode 31 of the opposite substrate 42, by oblique deposition.

In step S23 (application process), a polymeric initiator is stuck (applied) on the surface of the second alignment layer 32 (inorganic alignment layer). The method of sticking the polymeric initiator is the same as in the first alignment layer 28. Accordingly, the opposite substrate 42 with the polymeric initiator stuck on the surface of the second alignment layer 32 is completed. Next, a method of bonding the element substrate 41 with the opposite substrate 42 is described.

In step S31, the sealant 14 is applied onto the element substrate 41. In detail, the sealant 14 is applied onto the edge of the display region 19 (to surround the display region 19) of the element substrate 41 by changing the relative positional relationship between the element substrate 41 and a dispenser (or a discharge device).

In step S32, a liquid crystal panel before the liquid crystal device 11 is formed is formed by bonding the element substrate 41 with the opposite substrate 42. In detail, the element substrate 41 and the opposite substrate 42 are bonded by the sealant 14 applied on the element substrate 41. In more detail, it is performed while ensuring the longitudinal or transverse position accuracy in a plane of the substrates 41 and 42.

In step S33 (liquid crystal panel forming process), liquid crystal is injected into the structure from the liquid crystal injection hole 16 (see FIG. 1) of the liquid crystal panel and then the liquid crystal injection hole 16 is vacuum-locked. As the liquid crystal, a radical polymeric monomer is mixed with the liquid crystal composition having negative dielectric anisotropy, as described above. For example, a locking material 17 made of resin is used for the locking.

As the radical polymeric monomer, a substance having a liquid-crystalline framework, as shown in the following Chemical Formula 3, Chemical Formula 4, and Chemical Formula 5, such as acrylic acid, methacrylic acid, and acrylic acid ester, is preferable. In R1 and R2 in the following Chemical Formulae 3 to 5, at least one is a polymeric group, such as acrylate, methacrylate, vinyl, vinyloxy, and epoxy. Even if the radical polymeric monomer has a liquid-crystalline framework, for example, a reaction product of the radical polymeric monomer remains in the liquid crystal layer 15, it is possible to prevent an adverse effect on the alignment of the liquid crystal molecules.

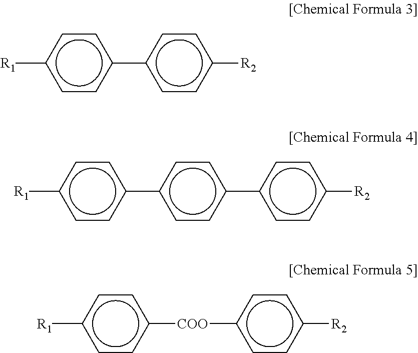

In step S34 (alignment restriction layer forming process), the atom transfer radical polymeric initiator and the radical polymeric monomer are polymerization-reacted by heating the liquid crystal panel. The temperature of the heating is, for example, 60° C. to 100° C. The polymerization reaction is promoted by heating. The following Chemical Formula 6 is a chemical structure formula when polymethylmethacrylate is polymerized. The following Chemical Formula 7 is a chemical structure formula when a liquid-crystalline monomer having a biphenyl framework is polymerized.

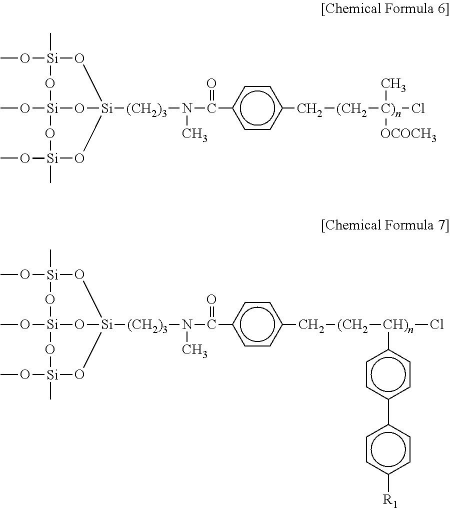

Accordingly, the first alignment restriction layer 28a (atom transfer radical polymer layer) is formed on the surface of the first alignment layer 28 and the second alignment restriction layer 32a (atom transfer radical polymer layer) is formed on the surface of the second alignment layer 32. Thereafter, the process is finished through a process of connecting the liquid crystal device 11 with the flexible substrate 100 (see FIG. 1 and FIG. 2).

FIG. 7 is a table showing the relationship between a radiation time and a specific resistance value, in the embodiment that forms the alignment layer by the atom transfer radical polymerization and a comparative example that forms an alignment layer by photo polymerization. Hereinafter, the specific resistance values of the embodiment and the comparative example are described with reference to the table in FIG. 7.

The table shown in FIG. 7 shows specific resistance values for each radiation time in the embodiment and the comparative example, which are obtained by radiating light to the liquid crystal device 11 of the embodiment in which the alignment layer is formed by the atom transfer radical polymerization and a liquid crystal device of the comparative example in which an alignment layer is formed by photopolymerization, using a liquid crystal projector. Further, the configuration of the liquid crystal device, other than the alignment layer, is the same in the embodiment and the comparative example.

In detail, a liquid crystal device in which an alignment layer is formed by the atom transfer radical polymerization from a biphenyl-based monomer material is the liquid crystal device 11 of the embodiment. Further, a liquid crystal device in which an alignment layer is formed by photo-polymerizing the same monomer material with the ultraviolet ray is the liquid crystal device of the comparative example. Further, specific resistance values (Ω·cm) when the radiation time (hrs) of light that is radiated to the liquid crystal devices are changed in five steps of 0, 50, 100, 200, and 500 were obtained. Further, changes in the specific resistance value of the liquid crystal layer 15 with the passage of time were obtained by radiating light of 5 W/cm² to both devices with an UHP lamp (extra high pressure mercury lamp) under the assumption that a liquid crystal projector is used.

When light is radiated to the liquid crystal device 11 of the embodiment, as the radiation time increases, the specific resistance value decreases, the specific resistance value is high at the initial stage, such that the change with the passage of time is very small. Further, there is no change in visual quality and alignment is stable.

When light is radiated to the liquid crystal device of the comparative example, it can be seen that the specific resistance value is low at the initial stage and impurities are generated at the polymerization time point. Further, decomposition reaction further proceeds with the passage of time. A flicker due to reduction in voltage maintenance rate was shown at the time point where the radiation time was 200 hours.

It is possible to achieve high visual quality if the liquid crystal device 11 of the embodiment in which the alignment is formed by the atom transfer radical polymerization in comparison to the liquid crystal device of the comparative example in which the alignment layer is formed by photopolymerization.

### Configuration of Electronic Apparatus

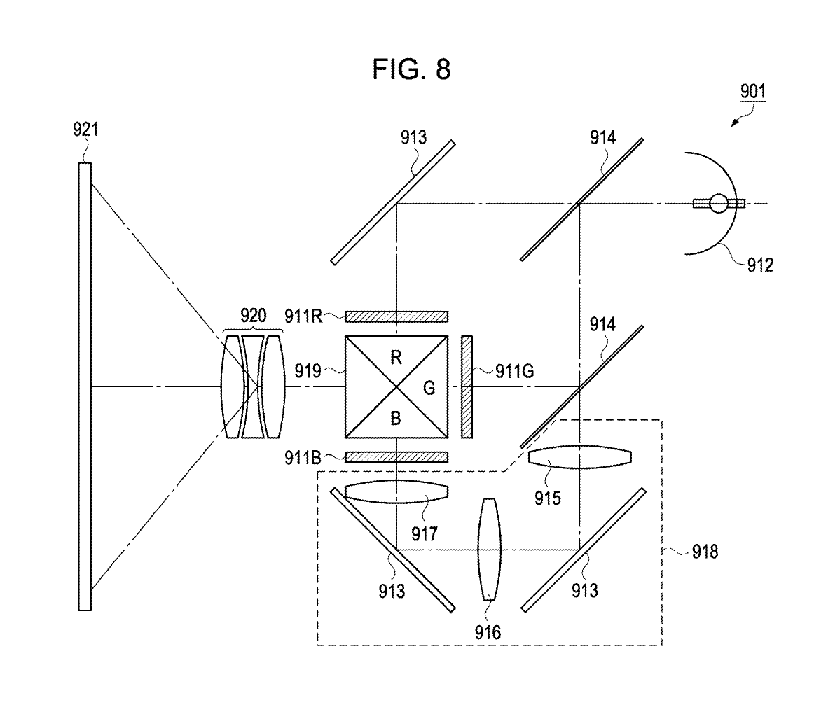

FIG. 8 is a schematic view showing the configuration of a liquid projector that is an example of an electronic apparatus equipped with the liquid crystal device described above. Hereinafter, the configuration of a liquid crystal projector equipped with the liquid crystal device is described with reference to FIG. 8.

As shown in FIG. 8, a liquid crystal projector 901 has a structure where three liquid crystal modules used in the liquid crystal device 11 are disposed and used for light valves 911R, 911G, and 911B for RGB, respectively.

In detail, when radiation light is generated from a lamp unit 912 that is a white light source, such as metal hydro lamp, the light is divided into three optic elements R, G, and B corresponding to the primary three colors of RGB by three mirrors 913 and two dichroic mirrors 914 and inducted to the light valves 911R, 911G, and 911B corresponding to each color. In particular, the optic element B is inducted through a relay lens system 918 composed of an incident lens 915, a relay lens 916, and an exit lens 917 to prevent light loss due to a long light path.

The optic elements R, G, and B corresponding to the primary three colors, which are modulated by the light valves 911R, 911G, and 911B, is composed again by a dichroic prism 919 and then projected to a screen 921 as a color image through a projection lens 920.

Further, as described above, the liquid crystal projector 901 with three liquid modules is not limited and, for example, a liquid crystal projector with one liquid crystal module may be used.

The liquid crystal projector 901 having the configuration can display with high visual quality because it is possible to prevent an alignment defect by using the liquid crystal modules in which the liquid crystal device 11 is adopted. Further, the liquid crystal device 11 described above may be used for, other than the liquid crystal projector 901 described above, various electronic apparatus, such as a high-accuracy EVF (Electric View Finder), a mobile phone, a mobile computer, a digital camera, a digital video camera, a television, a display, a vehicle-mounted equipment, an audio system, and a lighting system.

As described above, the following effects are achieved, according to the liquid crystal device 11 of the embodiment, the manufacturing method of the liquid crystal device 11, and the electronic apparatus.

(1) According to the liquid crystal device 11 of the embodiment and the manufacturing method thereof, since the alignment restriction layers 28a and 32a for stable alignment are formed only at the interface of the alignment layers 28 and 32 by applying (sticking) an atom transfer radical polymeric initiator to the alignment layers 28 and 32 formed of inorganic alignment layers and by reacting the atom transfer radical polymeric initiator with a radical polymeric monomer by heating, it is possible to prevent a monomer from remaining in the liquid crystal layer 15. Therefore, it is possible to prevent a reaction product (impurities) from damaging the liquid crystal molecules or an alignment defect from being generated by drifting of the reaction product in the liquid crystal layer 15. Further, since the alignment restriction layers 28a and 32a are not formed by radiating light, it is possible to prevent the liquid crystal layer 15 from being deteriorated. As a result, since damage to the liquid crystal layer 15 is prevented, the visual quality can be improved.

(2) According to an electronic apparatus of the embodiment, since the liquid crystal device 11 described above is provided, it is possible to prevent an alignment defect, such that it is possible to provide an electronic apparatus that can implement high visual quality.

Further, embodiments are not limited thereto and may be implemented by the following ways.

### Modified Example 1

As described above, it is not limitative that the alignment restriction layers 28a and 32a (atom transfer radical polymer layers) are formed on the surfaces of both of the first alignment layer 28 and the second alignment layer 32, and for example, an alignment restriction layer may be formed on only one alignment layer. Accordingly, although it may be considered that asymmetry reduces in comparison to the embodiment, it is possible to prevent an alignment defect of the liquid crystal molecules.

### Modified Example 2

As described above, the inorganic alignment layers, which are the first alignment layer 28 and the second alignment layer 32, are not limited to formation by the oblique deposition, and for example, may be formed by anisotropic sputtering.

The entire disclosure of Japanese Patent Application No. 2010-202772, filed Sep. 10, 2010 is expressly incorporated by reference herein.

What is claimed is:

1. A liquid crystal device that is formed by interposing a liquid crystal layer between a pair of substrates, comprising:
a vertical alignment layer that is disposed on the side facing the liquid crystal layer in at least one of the pair of substrates and substantially vertically aligns liquid crystal molecules of the liquid crystal layer; and
an alignment restriction layer that is disposed on the side facing the liquid crystal layer of the vertical alignment layer and restricts the alignment direction of the liquid crystal molecules, the alignment restriction layer being formed by polymerization of an atom transfer radical polymeric initiator bonded to the vertical alignment layer and a radical polymeric monomer contained in the liquid crystal layer.

2. The liquid crystal device according to claim 1,
wherein the vertical alignment layer is an inorganic alignment layer containing silicon oxide as a main element, the atom transfer radical polymeric initiator is a silane coupling agent, and a silanol group of the vertical alignment layer and the silane coupling agent are bonded.

3. The liquid crystal device according to claim 1,
wherein the radical polymeric monomer contains any one of an acrylate group, a methacrylate group, a vinyl group, a vinyloxy group, and an epoxy group.

4. The liquid crystal device according to claim 1,
wherein the radical polymeric monomer has a liquid-crystalline framework.

5. A manufacturing method of a liquid crystal device that is formed by interposing a liquid crystal layer between a pair of substrates, the method comprising:
forming an alignment layer, which forms a vertical alignment layer substantially aligning liquid crystal molecules of the liquid crystal layer, at a side facing the liquid crystal layer in at least one of the pair of substrates;
applying an atom transfer radical polymeric initiator onto the surface of the vertical alignment layer;
forming a liquid crystal panel by enclosing the liquid crystal layer containing a radical polymeric monomer between the pair of substrates; and
forming an alignment restriction layer at the side facing the liquid crystal layer of the vertical alignment layer by reacting the atom transfer radical polymeric initiator with the radical polymeric monomer contained in the liquid crystal layer.

6. The manufacturing method according to claim 5,
wherein the vertical alignment layer is an inorganic alignment layer containing silicon oxide as a main element, and
the atom transfer radical polymeric initiator is a silane coupling agent.

7. The manufacturing method according to claim 5,
wherein the radical polymeric monomer contains any one of an acrylate group, a methacrylate group, a vinyl group, a vinyloxy group, and an epoxy group.

8. The manufacturing method according to claim 5,
wherein the radical polymeric monomer has a liquid-crystalline framework.

9. An electronic apparatus equipped with the liquid crystal device according to claim 1.
